(19) United States
(12) Patent Application Publication
(10) Pub. No.: US 2003/0103068 A1
(43) Pub. Date: Jun. 5, 2003

(54) Universal server farm mass custom design tool

(75) Inventors: Kurtis Paul Longnecker, Plainfield, IL (US); Walter F. Schmidt, Darien, IL (US); James Ross Stark, Naperville, IL (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/004,948

(22) Filed: Dec. 5, 2001

(51) Int. Cl. G09G 5/00

(52) U.S. Cl. 345/700

(57) ABSTRACT

A method, system, and computer program product for producing a drawing of components and connections needed to implement a desired system, such as, for example, a server farm for web hosting, is provided. In one embodiment, the computer program product receives user needs of the user's desired system. The product then determines the components and connections needed to implement a system that satisfies the user needs and which comply with a set of protocols necessary to ensure that the system performs properly. In one embodiment, the user's needs are gathered through a series of graphical user interfaces. The product then generates drawing program input that provides instructions for producing a drawing of the system that satisfies the user's needs. The drawing program may be, for example, Visio, a product of the Microsoft Corporation of Redmond, Wash. The drawing program input is then sent to the drawing program which then generates a drawing of the desired system.

### BACKGROUND OF THE INVENTION

1. Technical Field:

The present invention relates generally to computer software and, more specifically to designing server configurations.

2. Description of Related Art:

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Many businesses wishing to exploit the web for business purposes must implement a network of servers and other components connected to the web to implement the functionality that propels their businesses. However, since the needs of individual businesses vary, providers of these components and services usually do not provide a “one-size-fits-all” web hosting system, but rather supply customized systems to fit the requirements of each of the customers individually. However, since it is customized to the needs of the individual enterprise, creating a complex schematic drawing showing the necessary resources and connections to supply the needs of the customer as well as satisfying the policy and protocol requirements of the provider can be very difficult and time consuming using existing drawing programs. Such a task is difficult for at least two reasons. First, the policy requirements of a provider for connecting various components together properly and the knowledge of which components are necessary can be very difficult for a layperson. Second, the interface for many, if not most, drawing programs are quite complex to use. Therefore, it would be desirable to have a method for creating schematic diagrams for web hosting hardware that is simple to use and less time consuming to use than prior art methods.

### SUMMARY OF THE INVENTION

The present invention provides a method, system, and computer program product for producing a drawing of components and connections needed to implement a desired system, such as, for example, a server farm for web hosting. In one embodiment, the computer program product receives user needs of the user's desired system. The product then determines the components and connections needed to implement a system that satisfies the user needs and which comply with a set of protocols necessary to ensure that the system performs properly. In one embodiment, the user's needs are gathered through a series of graphical user interfaces. The product then generates drawing program input that provides instructions for producing a drawing of the system that satisfies the user's needs. The drawing program may be, for example, Visio, a product of the Microsoft Corporation of Redmond, Wash. The drawing program input is then sent to the drawing program which then generates a drawing of the desired system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented in accordance with a preferred embodiment of the present invention;

FIG. 2 depicts a block diagram of a data processing system in which the present invention may be implemented;

FIG. 3 depicts a block diagram of a web hosting customization tool interfaced with a drawing program according to the present invention;

FIG. 4 depicts a pictorial diagram illustrating an exemplary drawing program graphical user interface;

FIGS. 5A-5N depict pictorial diagrams illustrating a series of exemplary graphical user interfaces that may be used by a user to supply the web hosting customization tool with the information necessary to construct a technical diagram with a drawing program in accordance with the present invention;

FIG. 6 depicts a process flow and program function illustrating an exemplary procedure for gathering user information regarding user needs and then creating a server farm design satisfying an enterprise's needs is depicted in accordance with the present invention;

FIG. 7 depicts an example of a drawing illustrating a server farm design produced using the present invention in conjunction with a drawing program; and

FIGS. 8A-8B depict an exemplary list of hardware necessary to implement the requirements of a user based on input (not shown) entered by the user into the tool.

### DETAILED DESCRIPTION OF THE PREFERRED EMBODIMENT

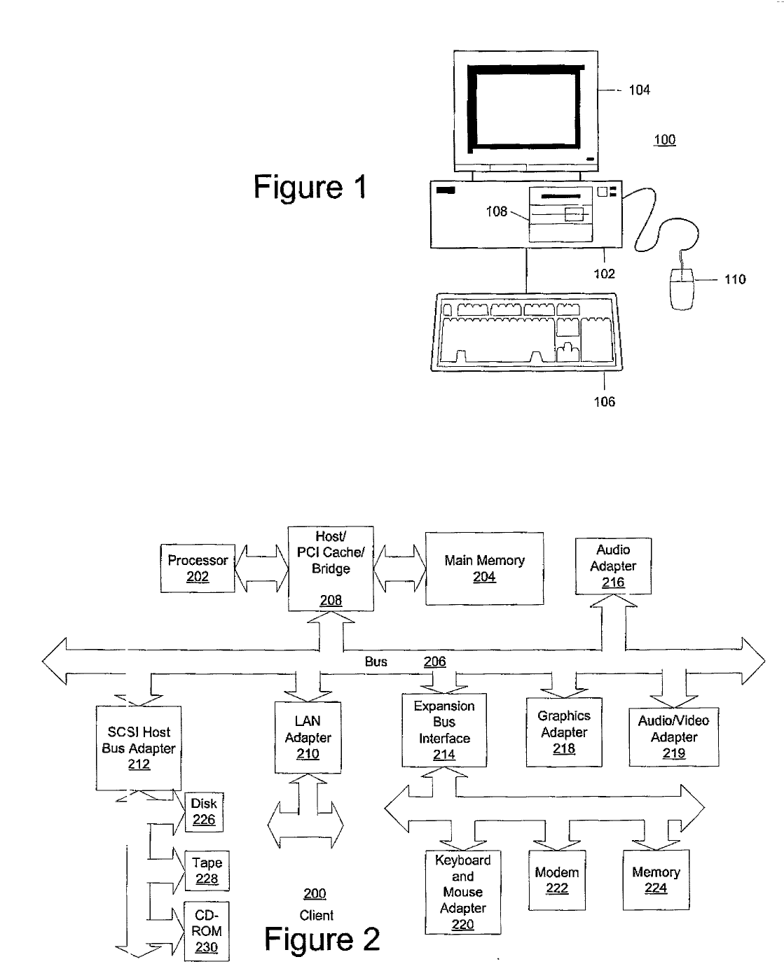

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides a method, system, and computer program product for presenting a simple user interface for constructing diagrams of configuring web hosting networks and other networks that must conform to specified guidelines.

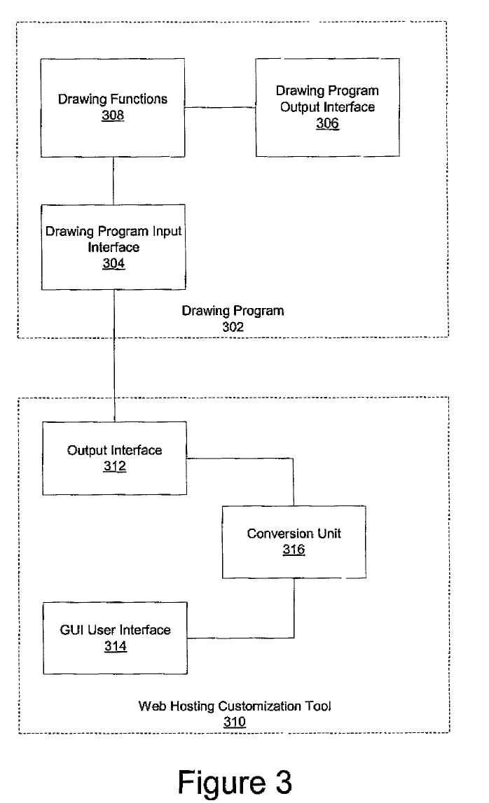

With reference now to FIG. 3, a block diagram of a web hosting customization tool 310 interfaced with a drawing program 302 is depicted according to the present invention. The drawing program 302, such as, for example, Visio, a product of Microsoft Corporation of Redmond Wash., includes a drawing program input interface 304, a drawing program output interface 306, and drawing functions 308. Drawing functions 308 provide the functionality of the drawing program to produce figures, lines, and pictures. Drawing program output interface 306 provides an interface between the drawing program 302 and an output device, such as, for example, a video display terminal. The drawing program input interface 304 provides a mechanism for the drawing program 302 to receive input commands from a user via, for example, a mouse or keyboard.

However, in the present invention, web hosting customization tool 310 includes an output interface 312 configured to interface with drawing program 302 through drawing program's 302 input interface 304. Web hosting customization tool 310 in conjunction with drawing program 302 allows a user to create a schematic layout or drawing of servers, routers and other equipment and their connections necessary to implement and host web sites. The drawing produced is sufficient to allow a technician to connect the various electronic devices in a manner to implement a web hosting site and provide the capabilities desired by the user.

Web hosting customization tool 310 allows a user to interact with a simpler interface than that typically provided by a drawing program 302 that allows a user to merely specify the requirements that the particular enterprise needs in order to perform their tasks. This input is received by Graphical user interface (GUI) 314. A conversion unit 316 includes rules necessary to implement a system fulfilling the requirements specified by the user. For example, in one embodiment, the web hosting customization tool's 310 GUI 314 encapsulates the rules comprising IBM's Mass Custom Policy. The conversion unit 316 thus, takes the user input from GUI 314 and converts the input into output that is formatted for the drawing program 302. The output interface 312 then communicates the customization tool's 310 output to the input 304 of drawing program 302. The drawing program 302 then produces a drawing conforming to the specifications of the user.

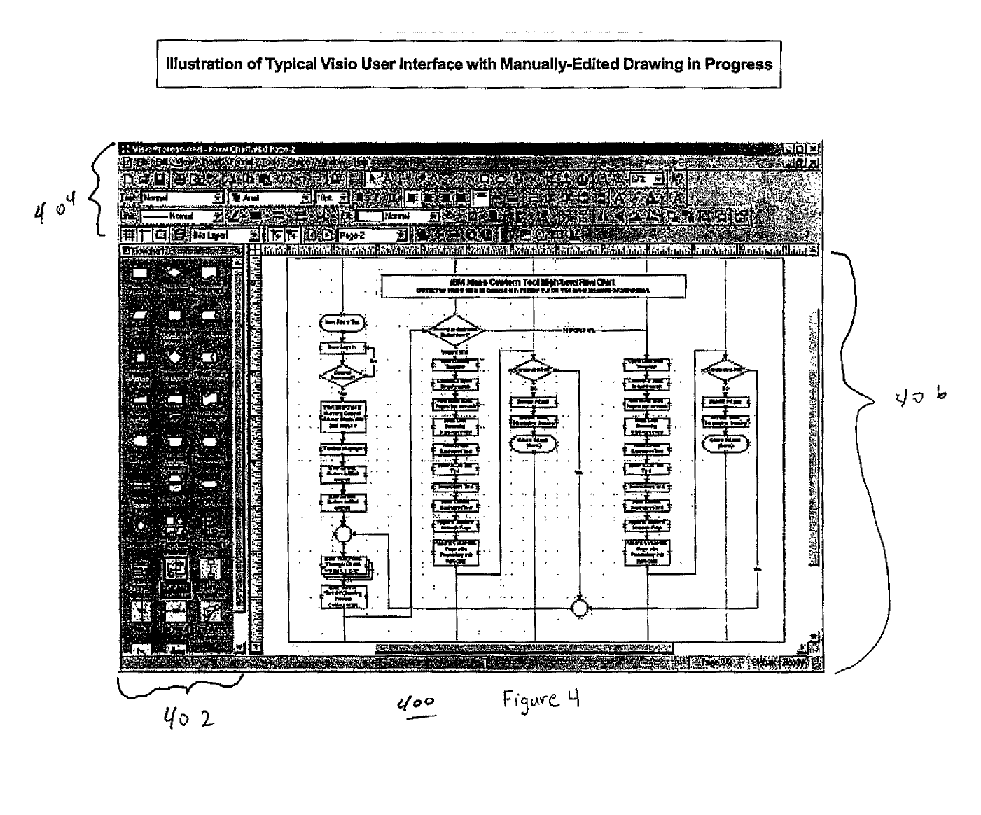

With reference now to FIG. 4, a pictorial diagram illustrating an exemplary drawing program graphical user interface is depicted. Drawing program graphical user interface (GUI) 400 includes a template palette 402, tool bars 404, and a drawing display 406. The tool bar 404 allows the user to open files, select drawing tools, open various template palettes, as well as other features. The template palette 402 contains various figures and pictures that are commonly used, allowing the user to merely drag and drop a picture rather than having to create the image from scratch. The drawings constructed by the user are displayed in drawing display 406. As can be seen from the picture, constructing complicated drawings using this interface could be quite time consuming and often difficult.

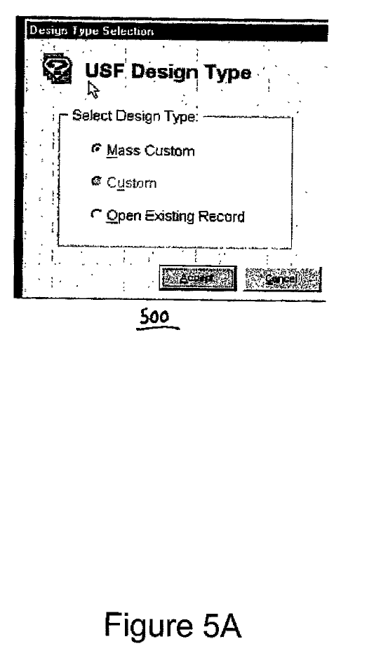

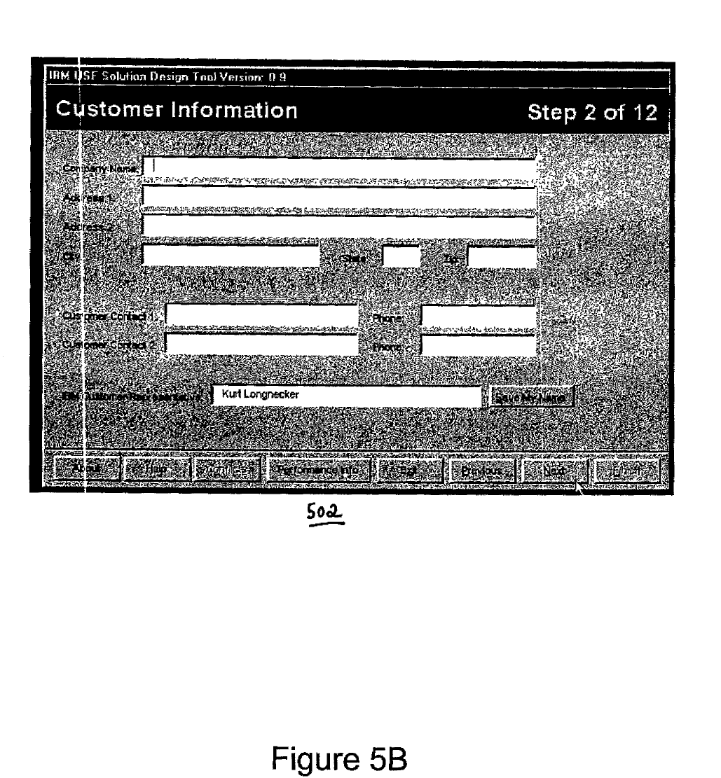

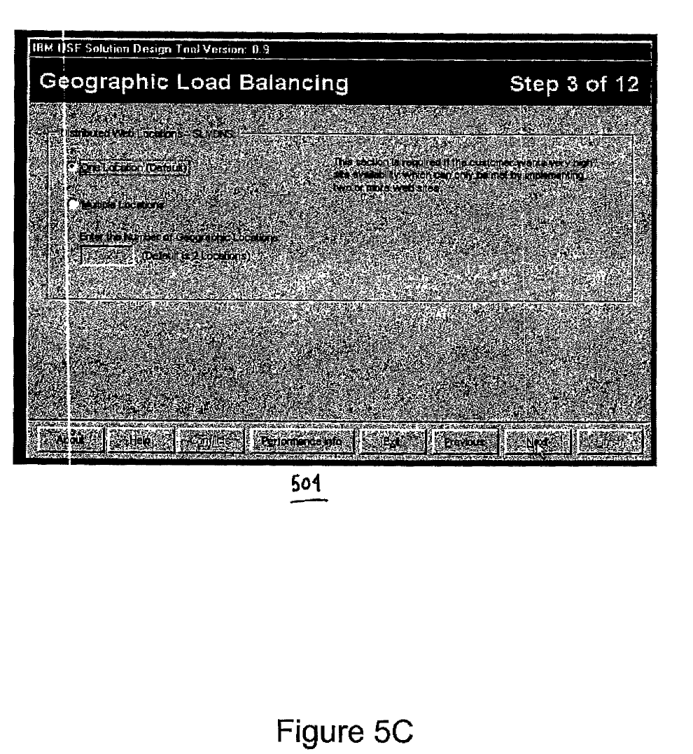

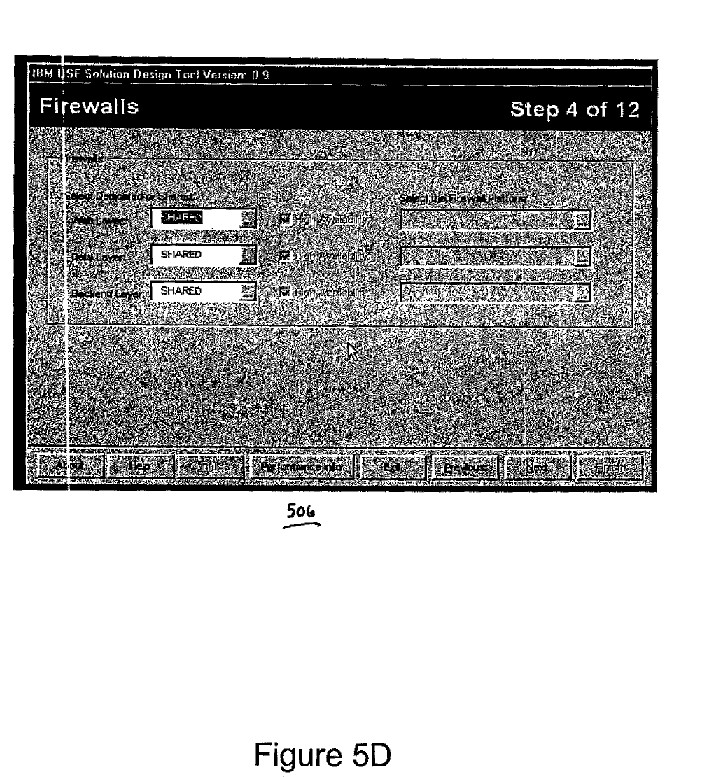

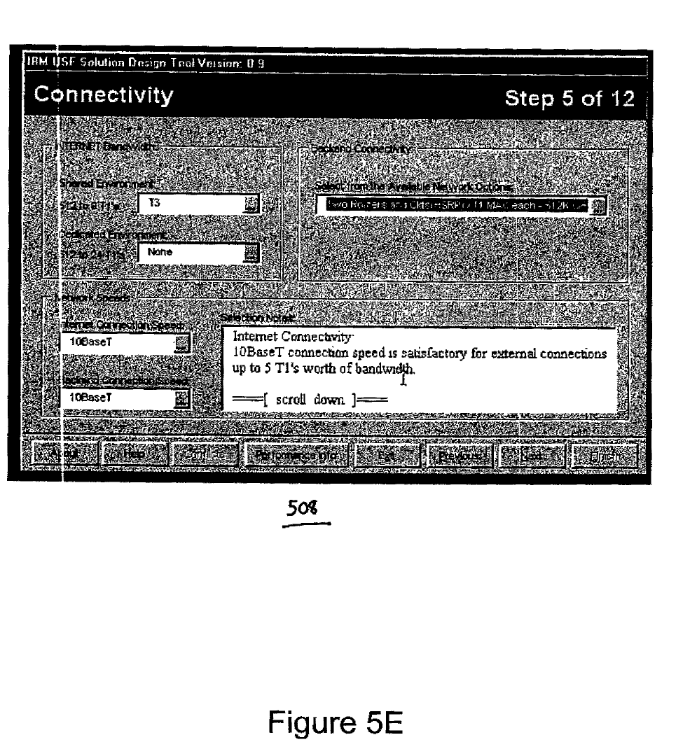

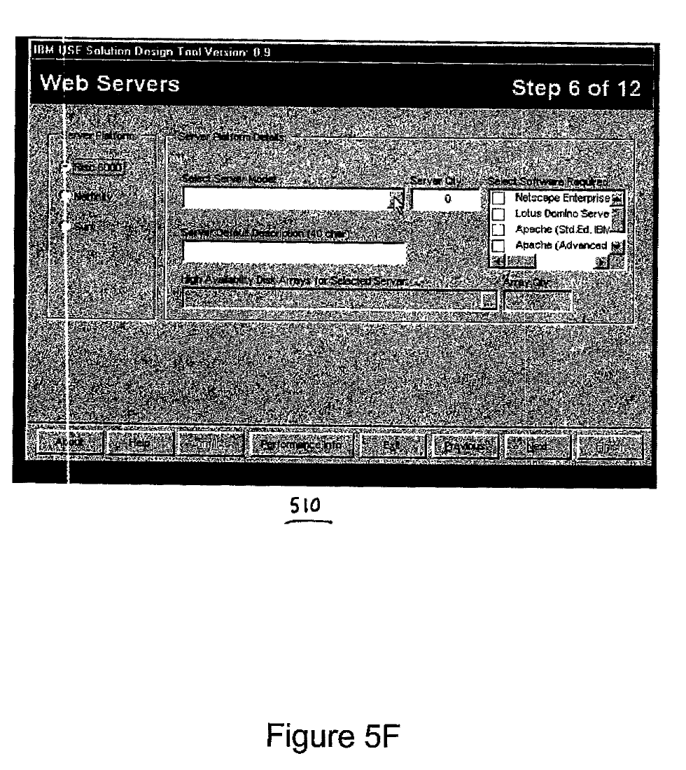

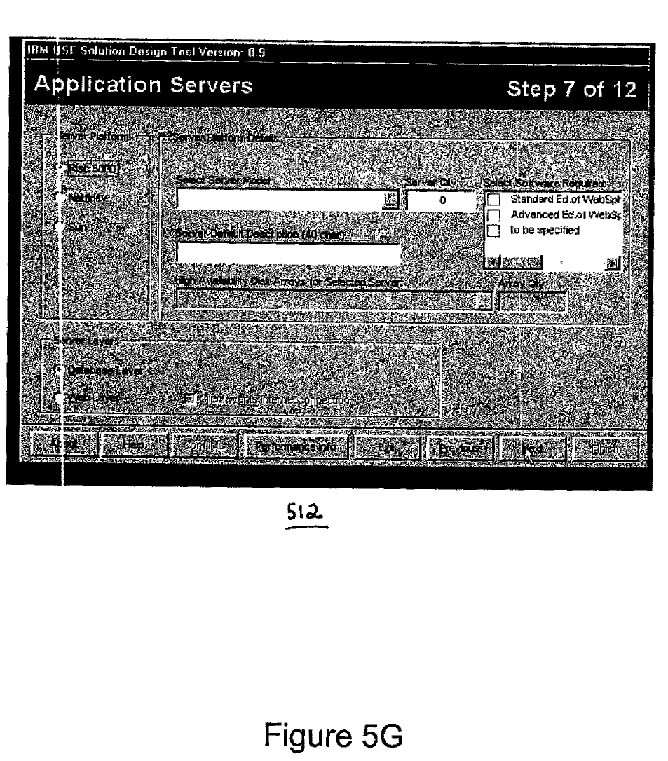

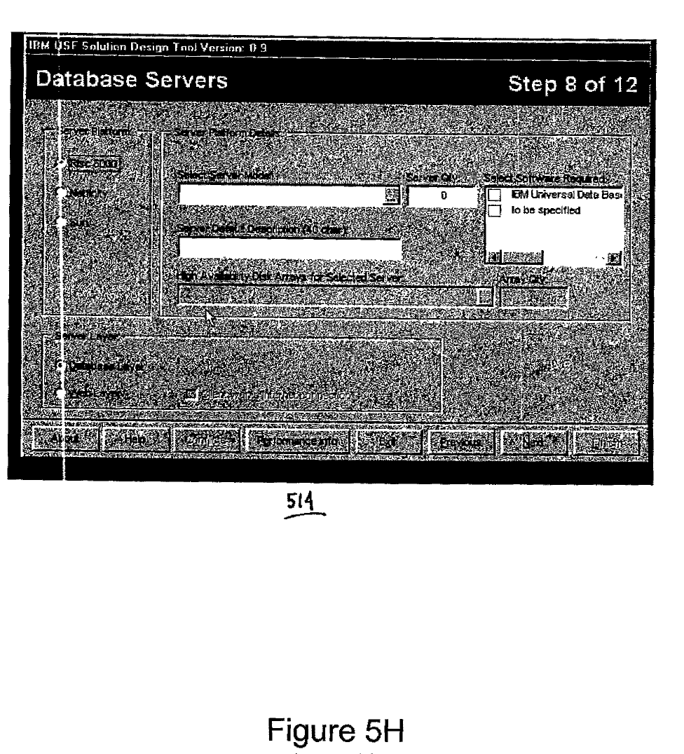

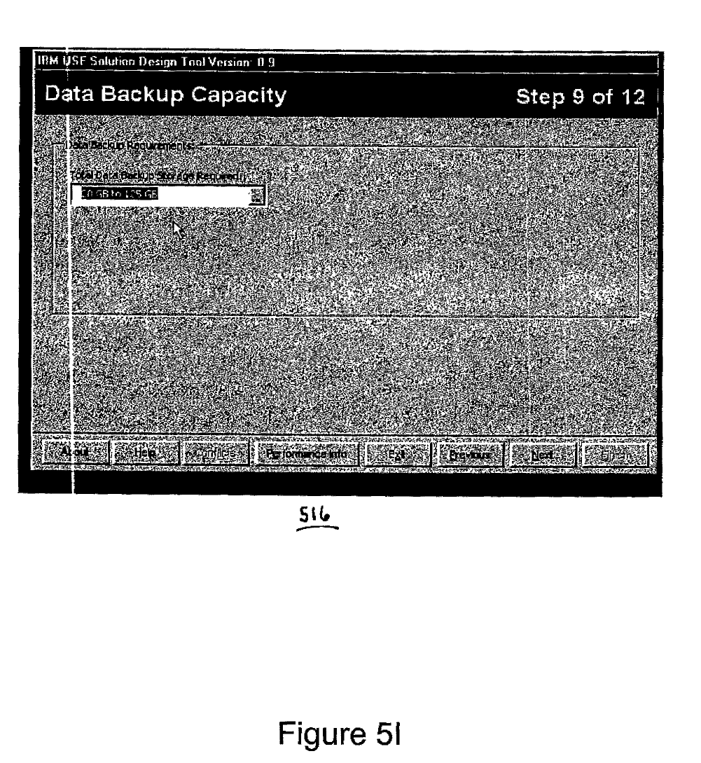

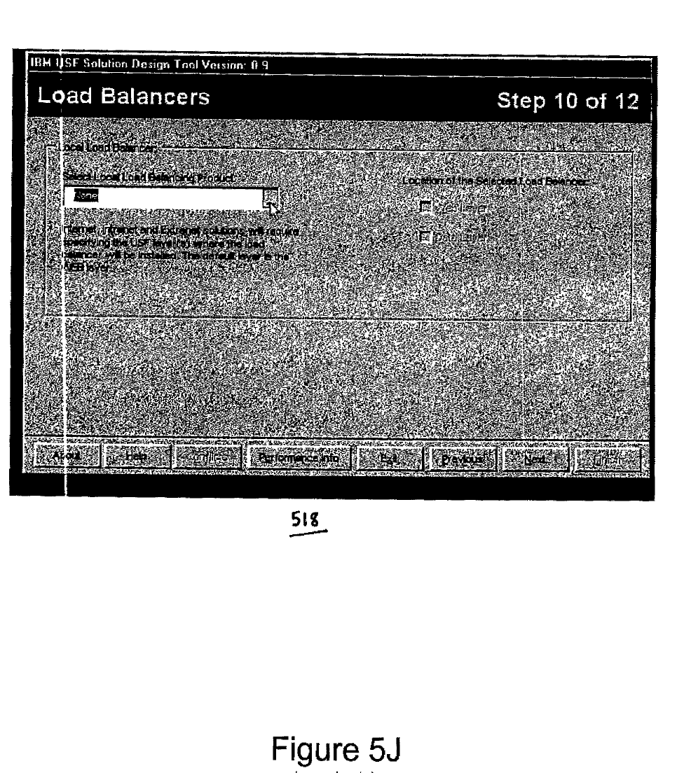

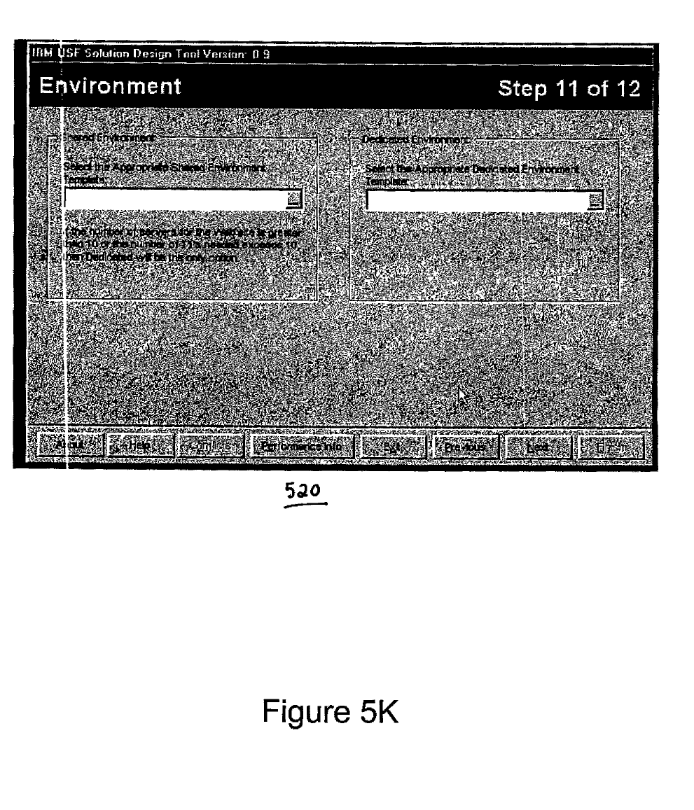

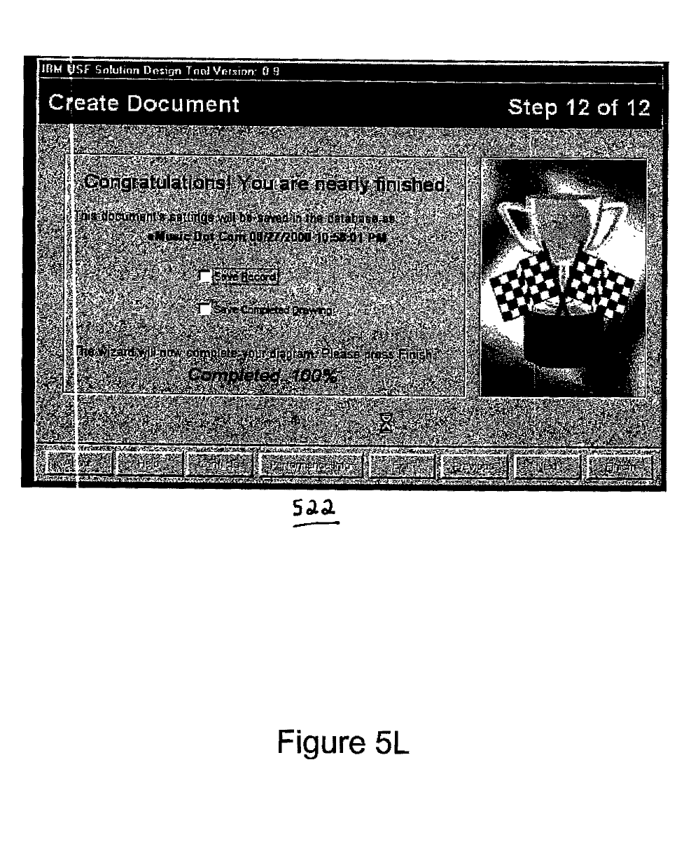

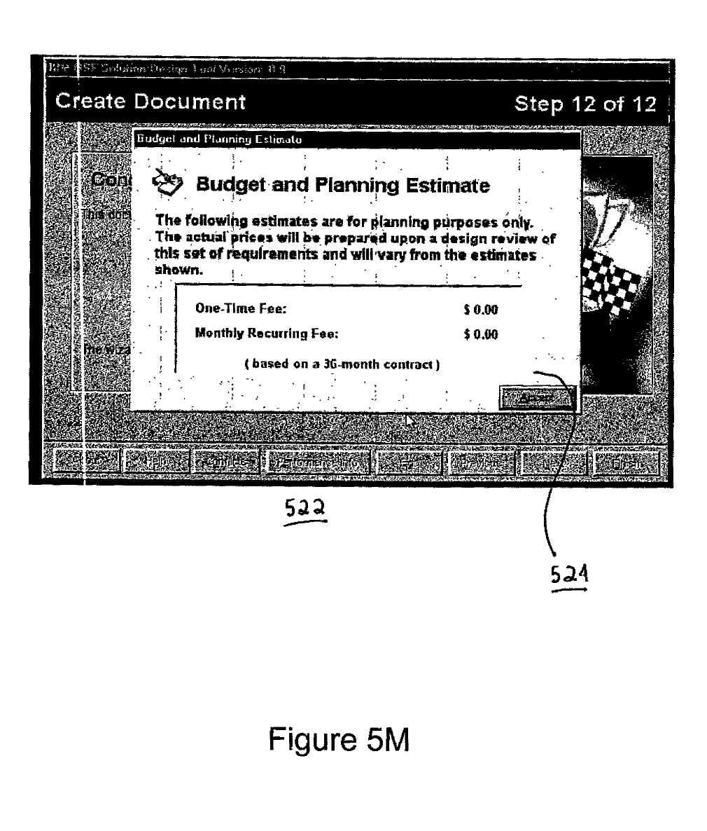

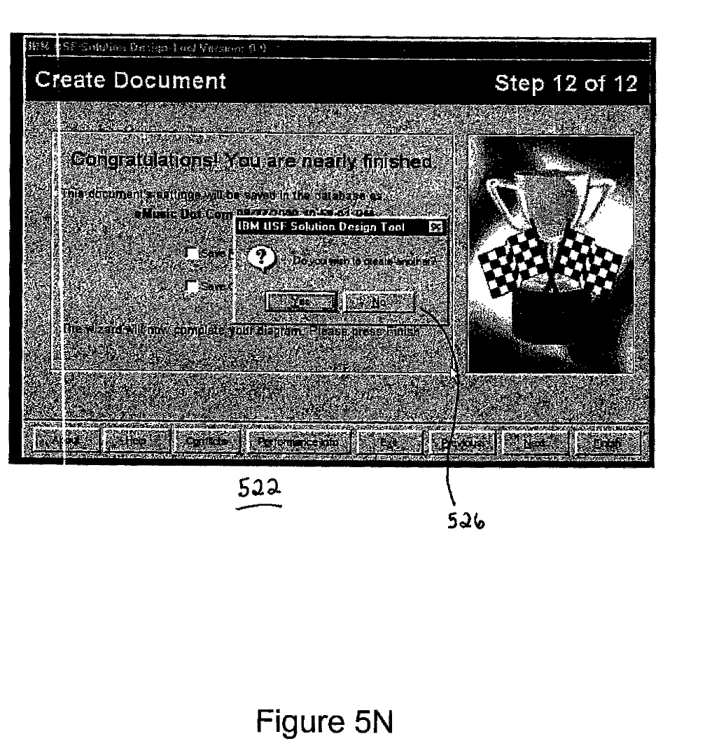

With reference now to FIGS. 5A-5N, pictorial diagrams illustrating a series of exemplary graphical user interfaces that may be used by a user to supply the web hosting customization tool with the information necessary to construct a technical diagram with a drawing program is depicted in accordance with the present invention. In FIG. 5A, Design type selection GUI 500 allows a user to select the design type, such as whether the user wishes to create a mass custom server farm design or open an existing record of a previously started customization. In FIG. 5B, customer information GUI 502 provides a user interface allowing a user to enter customer information such as, for example, company name, address, contact, and phone number. Once the user information has been entered, the user is presented with a geographic load balancing GUI 504 as depicted in FIG. 5C which allows the user to select whether the user wishes to have the server farm located at a single geographic location or at multiple locations.

The user is then presented with a firewalls GUI 506 as depicted in FIG. 5D. Firewalls GUI 506 allows a user to provide the design tool with information such as whether the web layer, data layer and backend layer are shared or dedicated, thus enabling the design tool to select the appropriate firewall design to comply with appropriate standards of server farm hosting. In FIG. 5E, a connectivity GUI 508 allows a user to select the internet bandwidth of the shared and dedicated environments, the backend connectivity and network speeds desired. The design tool then presents the user with a web servers GUI 510 as depicted in FIG. 5F, that allows the user to select from a plurality of server platforms, platform details, and quantities. Once the server details have been entered by the user, then the design tool presents the user with an application servers GUI 512 as depicted in FIG. 5G. The application servers GUI 512 allows the user to select the server platform, details, and other information about servers to be used to provide applications to users of the server farm. The user is then finally presented with a database servers GUI 514 as depicted in FIG. 5H that allows the user to specify information about the servers and quantities desired to be utilized as database servers in the server farm.

Once the server information has been selected, the user is presented with a data backup capacity GUI 516 as depicted in FIG. 5I. Data backup capacity GUI 516 provides a user interface allowing the user to select the data backup requirements needed by the enterprise that will use the server farm implemented from the server farm design created by the design tool from the choices selected by the user. The user is then presented with a load balancers GUI 518 as depicted in FIG. 5J. The load balancers GUI 518 allows a user to specify whether a load balancing product is desired and the location of the selected load balancer, if one has been selected. The user then selects the shared environment or dedicated environment template from environment GUI 520 as depicted in FIG. 5K. The design templates are drawing package drawings, such as Microsoft Visio drawings, which represent and define a base physical and logical network infrastructure and provide the foundation for the Mass Custom Tool. The templates represent the production environment in which a design prescribed with the tool comprises a total solution. The template and the layering of the selected server and network componentry architect a solution which can be built and deployed to meet real business requirements.

Once the environment template has been selected, the user has completed the entering the information that the design tool needs in order to produce a drawing of the desired server farm on a drawing program where the drawing provides the details necessary to implement the system according to the terms of a particular provider of server farm systems policies and protocols, such as, for example, the International Business Machine's Mass Custom Policy, which is hereby incorporated herein by reference for all purposes. The user is then presented with a create document GUI 522 as depicted in FIG. 5L that allows a user to save the record and to complete the drawing. The user may then be presented with a budget and planning estimate 524 as depicted in FIG. 5M that provides the user with an estimated cost to implement the system meeting the requirements specified by the user. Finally, the user will be presented with a create another GUI 526 as depicted in FIG. 5N that allows the user to end the session or to create another server farm design.

The GUI's depicted in FIGS. 5A-5N are provided merely as examples of GUI's that may be utilized in allowing a user to specify an enterprise's network computing needs in order that a design of an appropriate network satisfying these needs and satisfying a supplier's policies and protocols may be created. The specific information gathered may vary depending on the policies and protocols of the server farm supplier.

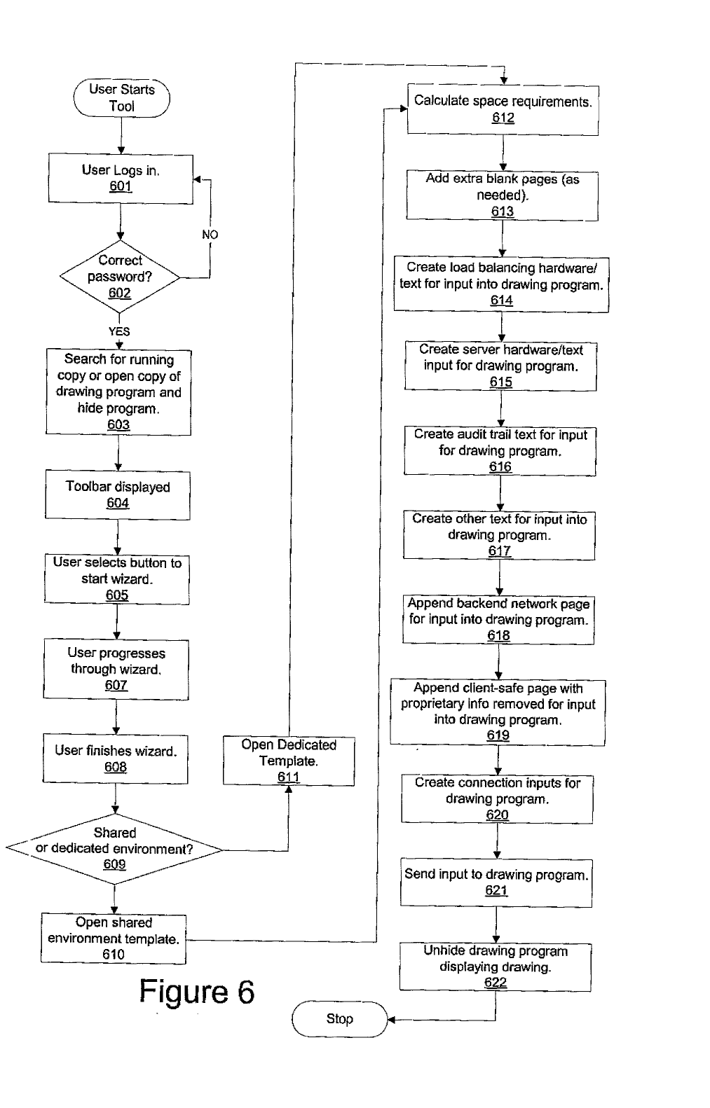

With reference now to FIG. 6, a process flow and program function illustrating an exemplary procedure for gathering user information regarding user needs and then creating a server farm design satisfying an enterprise's needs is depicted in accordance with the present invention. To begin, the user starts the design tool, such as, for example, web hosting customization tool 310 in FIG. 3, and logs into the tool (step 601). The tool determines whether the user has entered the correct password (step 602) and if not, prompts the user to log in again (step 601). If the user has entered the correct password, the tool searches for a running copy of a drawing program such as, for example, Visio, or starts the drawing program and then hides the drawing program (step 603). A toolbar is then displayed to the user (step 604) and the tool awaits the user to select the button to start the information wizard to gather information necessary to produce a server farm design (step 605). An example, of an information wizard is the series of GUI's presented to a user in one embodiment as depicted in FIGS. 5A-5N. The tool presents various user interfaces and prompts the user for information through the wizard (step 607) thus gathering the information necessary for the creation of the server farm design.

Once the user finishes the wizard process (step 608), the tool begins the drawing process and first determines whether the user has selected a shared or dedicated template (step 609). If the user has selected a shared environment, then the tool open's the shared template (step 610). If the user has selected a dedicated environment, then the tool opens the dedicated template (step 611). Once the appropriate template has been opened, the tool then calculates the space requirements needed for the design drawing (step 612). The tool also adds extra blank pages as needed to allow the design to be completely drawn (step 613).

Next, the tool creates load balancing hardware and text for input into drawing program (step 614). The tool then creates server hardware and text for input into drawing program (step 615) and creates and audit trail text for input to the drawing program (step 616). The tool then creates other text for input into drawing program (step 617) and appends backend network page for input into drawing program (step 618). The tool then appends client-safe page with proprietary information removed for input into drawing program (step 619) and created connection input for the drawing program (step 620). The connection input data is used to instruct the drawing program how to draw connections for the various servers and other components that are drawn. The tool then sends all of the input to the drawing program (step 621), which then creates a drawing based on the input received from the tool. The tool then unloads and the drawing program is revealed to display the drawing (step 622).

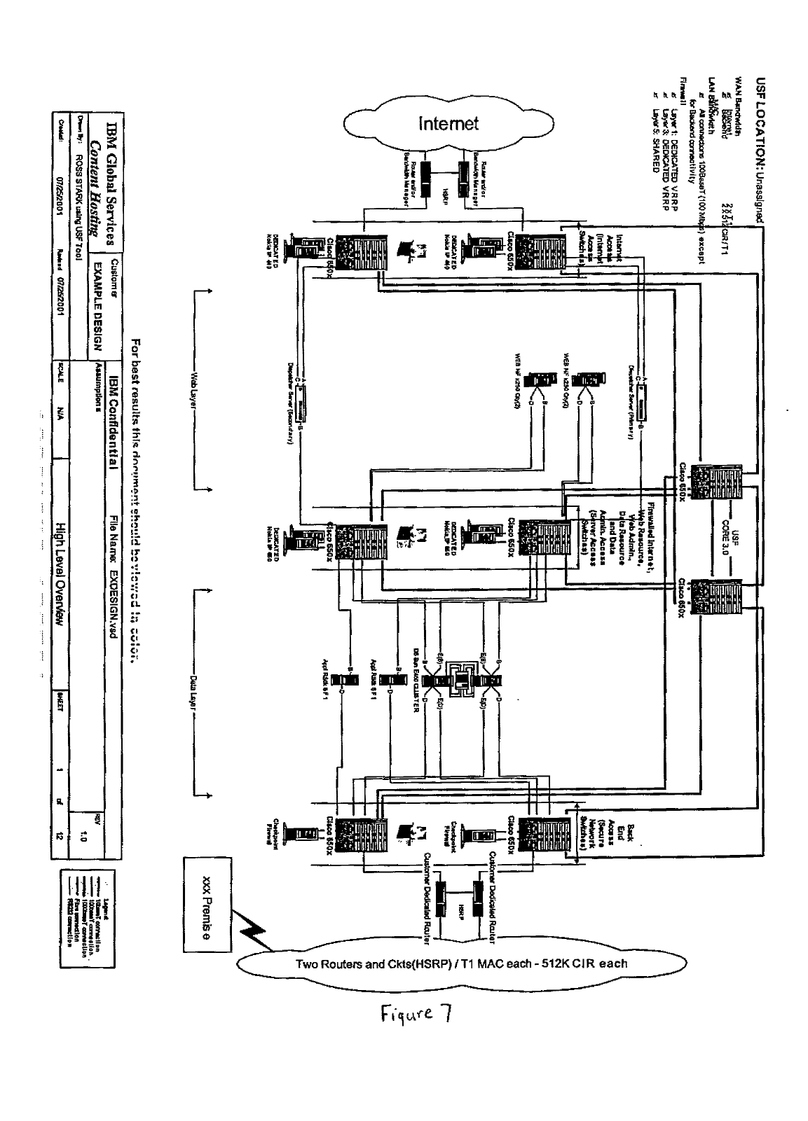

An example of a drawing illustrating a server farm design produced using the present invention in conjunction with a drawing program is depicted in FIG. 7. As can be seen from observing FIG. 7, diagrams of resources and connections necessary to implement a server farm are complex and detailed. Producing such a figure using a drawing package, such as depicted in FIG. 4, could be quite time consuming and difficult, especially for persons not familiar and comfortable with a drawing program. However, the present invention eliminates the need for a user to learn how to use a drawing program and also reduces the time to create a diagram such as depicted in FIG. 7 by providing a series of graphical user interfaces that allow a user to quickly select the requirements desired and then using policy and protocol requirements for a supplier's products to determine the products and connections needed to implement the user's desires. A set of inputs for a drawing program are then created by the tool based on the user's needs and the supplier's protocols to supply to a drawing program. The drawing program then creates a drawing illustrating the components and connections necessary to satisfy the user's needs. Thus, the present invention reduces the time and simplifies the knowledge required to produce a solution diagram for a server farm or web hosting site for e-business enterprises.

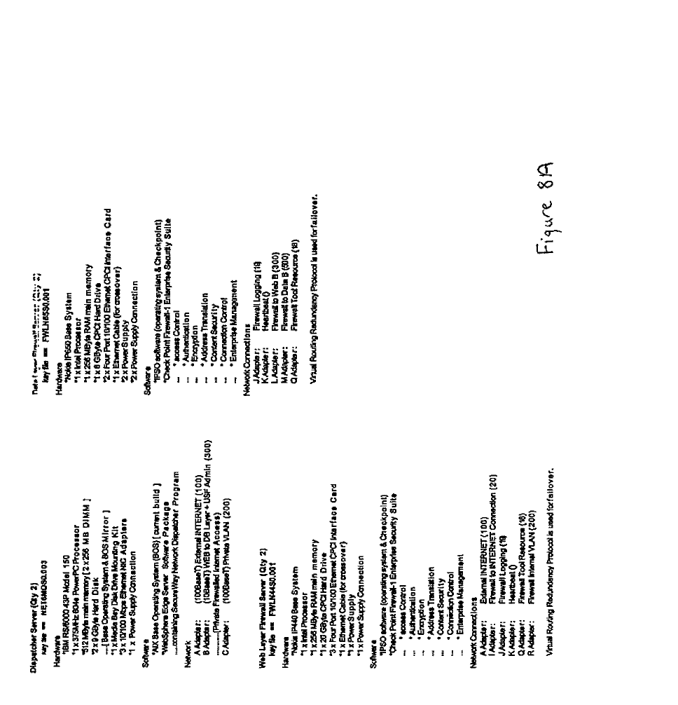

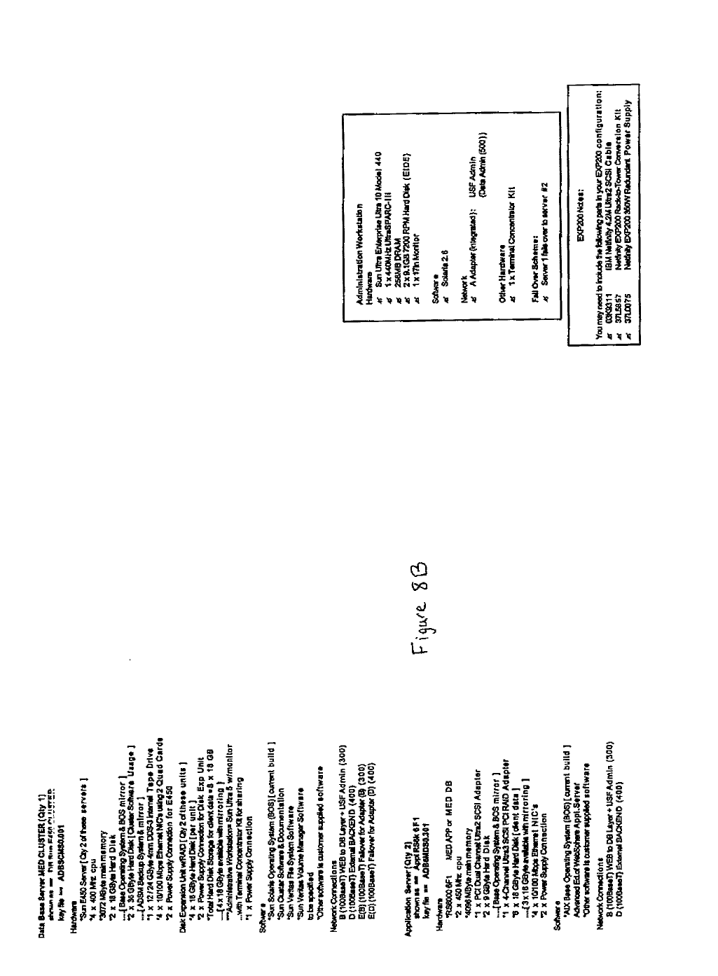

FIGS. 8A-8B depict an exemplary list of hardware necessary to implement the requirements of a user based on input (not shown) entered by the user into the tool. It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for producing a drawing of components and connections needed to implement a desired system, the method comprising:
receiving user needs of the desired system;
determining components and connections needed to implement a system that satisfies the user needs;
generating a drawing program input that provides instructions for producing a drawing of the system that satisfies the user needs; and
sending the drawing program input to a drawing program.

2. The method as recited in claim 1, further comprising:
providing a graphical user interface for receiving the user needs of the desired system.

3. The method as recited in claim 2, wherein the graphical user interface comprises a plurality of graphical user interfaces.

4. The method as recited in claim 3, wherein the plurality of graphical user interfaces are presented to the user sequentially.

5. The method as recited in claim 1, further comprising:
generating, with the drawing program, the drawing of the desired system.

6. The method as recited in claim 1, wherein the desired system is a system to implement web hosting.

7. The method as recited in claim 1, wherein determining components and connections needed to implement the system that satisfies the user needs comprises referencing a set of policies that must be satisfied in order for the desired system to function properly.

8. A computer program product in a computer readable media for use in a data processing system for producing a drawing of components and connections needed to implement a desired system, the computer program product comprising:
receiving instructions for receiving user needs of the desired system;
determining instructions for determining components and connections needed to implement a system that satisfies the user needs;
generating instructions for generating a drawing program input that provides instructions for producing a drawing of the system that satisfies the user needs; and
sending instructions for sending the drawing program input to a drawing program.

9. The computer program product as recited in claim 8, further comprising:
providing instructions for providing a graphical user interface for receiving the user needs of the desired system.

10. The computer program product as recited in claim 9, wherein the graphical user interface comprises a plurality of graphical user interfaces.

11. The computer program product as recited in claim 10, wherein the plurality of graphical user interfaces are presented to the user sequentially.

12. The computer program product as recited in claim 8, further comprising:
drawing instructions for generating, with the drawing program, the drawing of the desired system.

13. The computer program product as recited in claim 8, wherein the desired system is a system to implement web hosting.

14. The computer program product as recited in claim 8, wherein determining components and connections needed to implement the system that satisfies the user needs comprises referencing a set of policies that must be satisfied in order for the desired system to function properly.

15. A system for producing a drawing of components and connections needed to implement a desired system, the computer program product comprising:
a receiver which receives instructions for receiving user needs of the desired system;
a component determination unit which determines instructions for determining components and connections needed to implement a system that satisfies the user needs;
an instruction generating unit which generates instructions for generating a drawing program input that provides instructions for producing a drawing of the system that satisfies the user needs; and
a transmitter which sends instructions for sending the drawing program input to a drawing program.

16. The system as recited in claim 15, further comprising:
a graphical user interface unit which provides a graphical user interface for receiving the user needs of the desired system.

17. The system as recited in claim 16, wherein the graphical user interface comprises a plurality of graphical user interfaces.

18. The system as recited in claim 17, wherein the plurality of graphical user interfaces are presented to the user sequentially.

19. The system as recited in claim 15, further comprising:
drawing instructions for generating, with the drawing program, the drawing of the desired system.

20. The system as recited in claim 15, wherein the desired system is a system to implement web hosting.

21. The system as recited in claim 15, wherein determining components and connections needed to implement the system that satisfies the user needs comprises referencing a set of policies that must be satisfied in order for the desired system to function properly.

22. A system for producing a drawing of components and connections needed to implement a desired system, the system comprising:
receiving means for receiving user needs of the desired system;
determining means for determining components and connections needed to implement a system that satisfies the user needs;
instruction generating means for generating a drawing program input that provides instructions for producing a drawing of the system that satisfies the user needs; and
transmitting means for sending the drawing program input to a drawing program.

23. The system as recited in claim 22, further comprising:
interface means for providing a graphical user interface for receiving the user needs of the desired system.

24. The system as recited in claim 23, wherein the graphical user interface comprises a plurality of graphical user interfaces.

25. The system as recited in claim 24, wherein the plurality of graphical user interfaces are presented to the user sequentially.

26. The system as recited in claim 22, further comprising:
drawing program generating means for generating, with the drawing program, the drawing of the desired system.

27. The system as recited in claim 22, wherein the desired system is a system to implement web hosting.

28. The system as recited in claim 22, wherein determining components and connections needed to implement the system that satisfies the user needs comprises referencing a set of policies that must be satisfied in order for the desired system to function properly.
